(19) United States
(12) Patent Application Publication
(10) Pub. No.: US 2024/0114185 A1
(43) Pub. Date: Apr. 4, 2024

(54) VIDEO CODING FOR MACHINES (VCM) ENCODER AND DECODER FOR COMBINED LOSSLESS AND LOSSY ENCODING

(71) Applicants: Hari Kalva, BOCA RATON, FL (US); Borivoje Furht, BOCA RATON, FL (US); Velibor Adzic, Canton, GA (US)

(72) Inventors: Hari Kalva, BOCA RATON, FL (US); Borivoje Furht, BOCA RATON, FL (US); Velibor Adzic, Canton, GA (US)

(73) Assignee: OP Solultions, LLC, Amherst, MA (US)

(21) Appl. No.: 18/526,539

(22) Filed: Dec. 1, 2023

Related U.S. Application Data
(63) Continuation of application No. PCT/US2022/031726, filed on Jun. 1, 2022.
(60) Provisional application No. 63/208,241, filed on Jun. 8, 2021.

(51) Int. Cl. H04N 21/235; H04N 21/2343; H04N 21/236; H04N 21/435; H04N 21/4402

(52) U.S. Cl. CPC H04N 21/2355; H04N 21/2343; H04N 21/23614; H04N 21/4355; H04N 21/4402

(57) ABSTRACT

A video coding for machines (VCM) encoder for combined lossless and lossy encoding includes a feature encoder, the feature encoder configured to encode a sub-picture containing a feature in an input video and provide an indication of the sub-picture, and a video encoder, the video encoder configured to receive an indication of the sub-picture from the feature encoder and encode the sub-picture using a lossy encoding protocol.

### CROSS REFERENCE TO RELATED APPLICATIONS

This application is a continuation of international application PCT/US2022/031726 filed on Jun. 1, 2022, and titled VIDEO CODING FOR MACHINES (VCM) ENCODER AND DECODER FOR COMBINED LOSSLESS AND LOSSY ENCODING, which claims priority to U.S. Provisional Application No. 63/208,241 filed on Jun. 8, 2021, and entitled VIDEO CODING FOR MACHINES (VCM) ENCODER FOR COMBINED LOSSLESS AND LOSSY ENCODING, the disclosures of each such application is hereby incorporated herein by reference.

### FIELD OF THE INVENTION

The present invention generally relates to the field of video encoding and decoding. In particular, the present invention is directed to a video coding for machines (VCM) encoder for combined lossless and lossy encoding.

### BACKGROUND

A video codec can include an electronic circuit or software that compresses or decompresses digital video. It can convert uncompressed video to a compressed format or vice versa. In the context of video compression, a device that compresses video (and/or performs some function thereof) can typically be called an encoder, and a device that decompresses video (and/or performs some function thereof) can be called a decoder.

A format of the compressed data can conform to a standard video compression specification. The compression can be lossy in that the compressed video lacks some information present in the original video. A consequence of this can include that decompressed video can have lower quality than the original uncompressed video because there is insufficient information to accurately reconstruct the original video.

There can be complex relationships between the video quality, the amount of data used to represent the video (e.g., determined by the bit rate), the complexity of the encoding and decoding algorithms, sensitivity to data losses and errors, ease of editing, random access, end-to-end delay (e.g., latency), and the like.

Motion compensation can include an approach to predict a video frame or a portion thereof given a reference frame, such as previous and/or future frames, by accounting for motion of the camera and/or objects in the video. It can be employed in the encoding and decoding of video data for video compression, for example in the encoding and decoding using the Motion Picture Experts Group (MPEG)'s advanced video coding (AVC) standard (also referred to as H.264). Motion compensation can describe a picture in terms of the transformation of a reference picture to the current picture. The reference picture can be previous in time when compared to the current picture, from the future when compared to the current picture. When images can be accurately synthesized from previously transmitted and/or stored images, compression efficiency can be improved.

### SUMMARY OF THE DISCLOSURE

A video coding for machines (VCM) encoder is provided that includes a feature encoder configured to receive source video and encode a sub-picture containing a feature in the source input video and provide an indication of the sub-picture. The VCM encoder also includes a video encoder encoder configured to receive source video, receive an indication of the sub-picture from the feature encoder, and encode the sub-picture. A multiplexor coupled to the feature encoder and video encoder and provides a VCM encoded bitstream with both feature data and video data.

In some embodiments, the video encoder is a lossless encoder, a lossy encoder or a combination thereof. The video encoder may encode the video in accordance with any applicable encoding standard, such as VVC, AVC, and the like.

A VCM decoder includes a feature decoder, the feature decoder receiving an encoded bitstream having encoded feature data and video data therein, the feature decoder providing decoded feature data for machine applications. The VCM decoder also includes a video decoder, the video decoder receiving the encoded bitstream and feature data from the feature decoder, the video decoder provided decoded video, such as suitable for human viewing.

In some embodiments the VCM decoder is configured to decode video encoded with an applicable standard, such as VVC, AVC and the like.

These and other aspects and features of non-limiting embodiments of the present invention will become apparent to those skilled in the art upon review of the following description of specific non-limiting embodiments of the invention in conjunction with the accompanying drawings.

### BRIEF DESCRIPTION OF THE DRAWINGS

For the purpose of illustrating the invention, the drawings show aspects of one or more embodiments of the invention. However, it should be understood that the present invention is not limited to the precise arrangements and instrumentalities shown in the drawings, wherein:

FIG. 1 is a block diagram illustrating an exemplary embodiment of a VCC encoder;

FIG. 2 is a block diagram illustrating an exemplary embodiment of a VCM encoder;

FIG. 3 is a screenshot of an exemplary embodiment of an image with a sub-picture including a feature;

FIG. 4 is a block diagram illustrating an exemplary embodiment of a video decoder;

FIG. 5 is a block diagram illustrating an exemplary embodiment of a video encoder; and

FIG. 6 is a block diagram of a computing system that can be used to implement any one or more of the methodologies disclosed herein and any one or more portions thereof.

The drawings are not necessarily to scale and may be illustrated by phantom lines, diagrammatic representations, and fragmentary views. In certain instances, details that are not necessary for an understanding of the embodiments or that render other details difficult to perceive may have been omitted.

### DETAILED DESCRIPTION

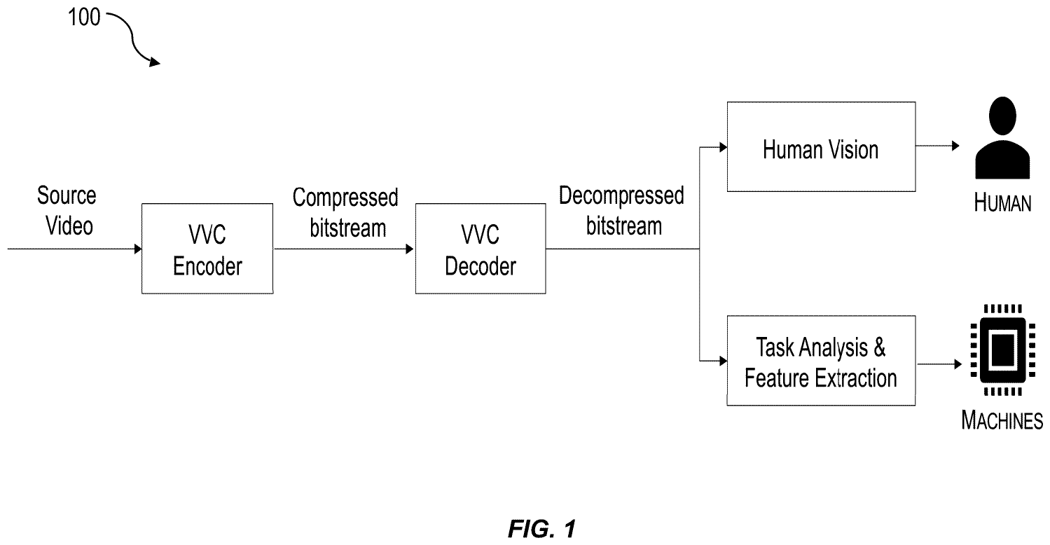

In many applications, such as surveillance systems with multiple cameras, intelligent transportation, smart city applications, and intelligent industry applications, traditional video coding requires compression of large number of videos from cameras and transmission through the network to machines and for human consumption. Then, at a machine site, algorithms for feature extraction are applied typically using convolutional neural networks or deep learning techniques including object detection, event action recognition, pose estimation and others. FIG. 1 shows standard VVC coder applied for machines.

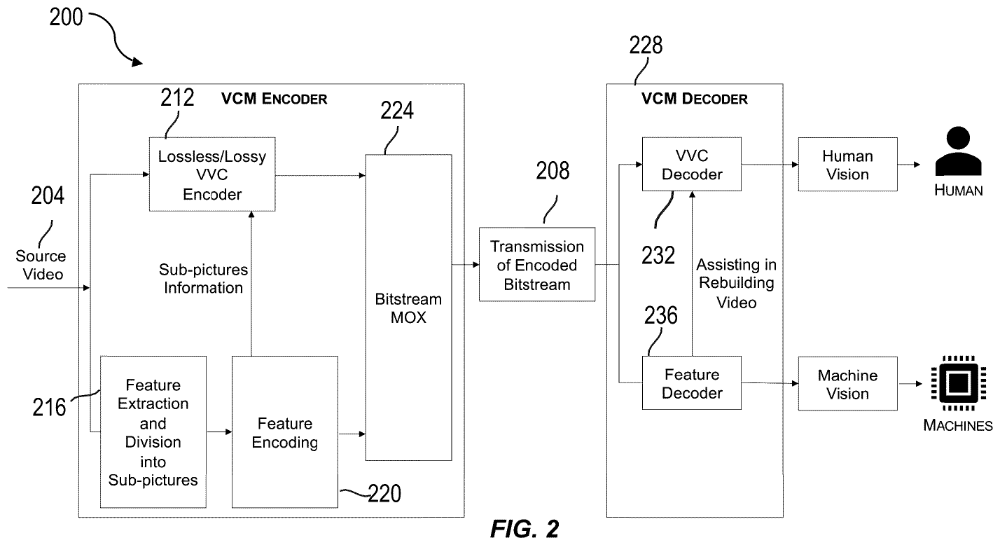

A problem with above-described approaches is a massive video transmission from multiple cameras, which may take significant time for efficient and fast real-time analysis and decision-making. Embodiments of a video coding for machines (VCM) approach described herein resolve this problem, without limitation, by both encoding video and extracting some features at a transmitter site and then transmit a resulting encoded bit stream to a VCM decoder. At a VCM decoder site video may be decoded for human vision and features may be decoded for machines. Referring now to FIG. 2, an exemplary embodiment of encoder for video coding for machines (VCM) is illustrated. VCM encoder 200 may be implemented using any circuitry including without limitation digital and/or analog circuitry; VCM encoder 200 may be configured using hardware configuration, software configuration, firmware configuration, and/or any combination thereof. VCM encoder 200 may be implemented as a computing device and/or as a component of a computing device, which may include without limitation any computing device as described below. In an embodiment, VCM encoder 200 may be configured to receive an input video 204 and generate an output bitstream 208. Reception of an input video 204 may be accomplished in any manner described below. A bitstream may include, without limitation, any bitstream as described below.

VCM encoder 200 may include, without limitation, a pre-processor, a video encoder 212, a feature extractor 216, an optimizer, a feature encoder 220, and/or a multiplexor 224. Pre-processor may receive input video 204 stream and parse out video, audio and metadata sub-streams of the stream. Pre-processor may include and/or communicate with decoder as described in further detail below; in other words, Pre-processor may have an ability to decode input streams. This may allow, in a non-limiting example, decoding of an input video 204, which may facilitate downstream pixel-domain analysis.

Further referring to FIG. 2, VCM encoder 200 may operate in a hybrid mode and/or in a video mode; when in the hybrid mode VCM encoder 200 may be configured to encode a visual signal that is intended for human consumers, to encode a feature signal that is intended for machine consumers; machine consumers may include, without limitation, any devices and/or components, including without limitation computing devices as described in further detail below. Input signal may be passed, for instance when in hybrid mode, through pre-processor.

Still referring to FIG. 2, video encoder 212 may include without limitation any video encoder 212 as described in further detail below. When VCM encoder 200 is in hybrid mode, VCM encoder 200 may send unmodified input video 204 to video encoder 212 and a copy of the same input video 204, and/or input video 204 that has been modified in some way, to feature extractor 216. Modifications to input video 204 may include any scaling, transforming, or other modification that may occur to persons skilled in the art upon reviewing the entirety of this disclosure. For instance, and without limitation, input video 204 may be resized to a smaller resolution, a certain number of pictures in a sequence of pictures in input video 204 may be discarded, reducing framerate of the input video 204, color information may be modified, for example and without limitation by converting an RGB video might be converted to a grayscale video, or the like. Still referring to FIG. 2, video encoder 212 and feature extractor 216 are connected and might exchange useful information in both directions. For example, and without limitation, video encoder 212 may transfer motion estimation information to feature extractor 216, and vice-versa.

Video encoder 212 may provide Quantization mapping and/or data descriptive thereof based on regions of interest (ROI), which video encoder 212 and/or feature extractor 216 may identify, to feature extractor 216, or vice-versa. Video encoder 212 may provide to feature extractor 216 data describing one or more partitioning decisions based on features present and/or identified in input video 204, input signal, and/or any frame and/or subframe thereof feature extractor 216 may provide to video encoder 212 data describing one or more partitioning decisions based on features present and/or identified in input video 204, input signal, and/or any frame and/or subframe thereof. Video encoder 212 feature extractor 216 may share and/or transmit to one another temporal information for optimal group of pictures (GOP) decisions. Each of these techniques and/or processes may be performed, without limitation, as described in further detail below.

With continued reference to FIG. 2, feature extractor 216 may operate in an offline mode or in an online mode. Feature extractor 216 may identify and/or otherwise act on and/or manipulate features. A “feature,” as used in this disclosure, is a specific structural and/or content attribute of data. Examples of features may include SIFT, audio features, color hist, motion hist, speech level, loudness level, or the like. Features may be time stamped. Each feature may be associated with a single frame of a group of frames. Features may include high level content features such as timestamps, labels for persons and objects in the video, coordinates for objects and/or regions-of-interest, frame masks for region-based quantization, and/or any other feature that may occur to persons skilled in the art upon reviewing the entirety of this disclosure. As a further non-limiting example, features may include features that describe spatial and/or temporal characteristics of a frame or group of frames. Examples of features that describe spatialand/or temporal characteristics may include motion, texture, color, brightness, edge count, blur, blockiness, or the like. When in offline mode, all machine models as described in further detail below may be stored at encoder and/or in memory of and/or accessible to encoder. Examples of such models may include, without limitation, whole or partial convolutional neural networks, keypoint extractors, edge detectors, salience map constructors, or the like. When in online mode one or more models may be communicated to feature extractor 216 by a remote machine in real time or at some point before extraction.

Still referring to FIG. 2, feature encoder 220 is configured for encoding a feature signal, for instance and without limitation as generated by feature extractor 216. In an embodiment, after extracting the features feature extractor 216 may pass extracted features to feature encoder 220. Feature encoder 220 may use entropy coding and/or similar techniques, for instance and without limitation as described below, to produce a feature stream, which may be passed to multiplexor 224. Video encoder 212 and/or feature encoder 220 may be connected via optimizer; optimizer may exchange useful information between those video encoder 212 and feature encoder 220. For example, and without limitation, information related to codeword construction and/or length for entropy coding may be exchanged and reused, via optimizer, for optimal compression.

In an embodiment, and continuing to refer to FIG. 2, video encoder 212 may produce a video stream; video stream may be passed to multiplexor 224. Multiplexor 224 may multiplex video stream with a feature stream generated by feature encoder 220; alternatively or additionally, video and feature bitstreams may be transmitted over distinct channels, distinct networks, to distinct devices, and/or at distinct times or time intervals (time multiplexing). Each of video stream and feature stream may be implemented in any manner suitable for implementation of any bitstream as described in this disclosure. In an embodiment, multiplexed video stream and feature stream may produce a hybrid bitstream, which may be is transmitted as described in further detail below.

Still referring to FIG. 2, where VCM encoder 200 is in video mode, VCM encoder 200 may use video encoder 212 for both video and feature encoding. Feature extractor 216 may transmit features to video encoder 212; the video encoder 212 may encode features into a video stream that may be decoded by a corresponding video decoder 232. It should be noted that VCM encoder 200 may use a single video encoder 212 for both video encoding and feature encoding, in which case it may use different set of parameters for video and features; alternatively, VCM encoder 200 may two separate video encoder 212s, which may operate in parallel.

Still referring to FIG. 2, system 100 may include and/or communicate with, a VCM decoder 228. VCM decoder 228 and/or elements thereof may be implemented using any circuitry and/or type of configuration suitable for configuration of VCM encoder 200 as described above. VCM decoder 228 may include, without limitation, a demultiplexor. Demultiplexor may operate to demultiplex bitstreams if multiplexed as described above; for instance and without limitation, demultiplexor may separate a multiplexed bitstream containing one or more video bitstreams and one or more feature bitstreams into separate video and feature bitstreams.

Continuing to refer to FIG. 2, VCM decoder 228 may include a video decoder 232. Video decoder 232 may be implemented, without limitation in any manner suitable for a decoder as described in further detail below. In an embodiment, and without limitation, video decoder 232 may generate an output video, which may be viewed by a human or other creature and/or device having visual sensory abilities.

Still referring to FIG. 2, VCM decoder 228 may include a feature decoder 236. In an embodiment, and without limitation, feature decoder 236 may be configured to provide one or more decoded data to a machine. Machine may include, without limitation, any computing device as described below, including without limitation any microcontroller, processor, embedded system, system on a chip, network node, or the like. Machine may operate, store, train, receive input from, produce output for, and/or otherwise interact with a machine model as described in further detail below. Machine may be included in an Internet of Things (IOT), defined as a network of objects having processing and communication components, some of which may not be conventional computing devices such as desktop computers, laptop computers, and/or mobile devices. Objects in IoT may include, without limitation, any devices with an embedded microprocessor and/or microcontroller and one or more components for interfacing with a local area network (LAN) and/or wide-area network (WAN); one or more components may include, without limitation, a wireless transceiver, for instance communicating in the 2.4-2.485 GHz range, like BLUETOOTH transceivers following protocols as promulgated by Bluetooth SIG, Inc. of Kirkland, Wash, and/or network communication components operating according to the MODBUS protocol promulgated by Schneider Electric SE of Rueil-Malmaison, France and/or the ZIGBEE specification of the IEEE 802.15.4 standard promulgated by the Institute of Electronic and Electrical Engineers (IEEE). Persons skilled in the art, upon reviewing the entirety of this disclosure, will be aware of various alternative or additional communication protocols and devices supporting such protocols that may be employed consistently with this disclosure, each of which is contemplated as within the scope of this disclosure.

With continued reference to FIG. 2, each of VCM encoder 200 and/or VCM decoder 228 may be designed and/or configured to perform any method, method step, or sequence of method steps in any embodiment described in this disclosure, in any order and with any degree of repetition. For instance, each of VCM encoder 200 and/or VCM decoder 228 may be configured to perform a single step or sequence repeatedly until a desired or commanded outcome is achieved; repetition of a step or a sequence of steps may be performed iteratively and/or recursively using outputs of previous repetitions as inputs to subsequent repetitions, aggregating inputs and/or outputs of repetitions to produce an aggregate result, reduction or decrement of one or more variables such as global variables, and/or division of a larger processing task into a set of iteratively addressed smaller processing tasks. Each of VCM encoder 200 and/or VCM decoder 228 may perform any step or sequence of steps as described in this disclosure in parallel, such as simultaneously and/or substantially simultaneously performing a step two or more times using two or more parallel threads, processor cores, or the like; division of tasks between parallel threads and/or processes may be performed according to any protocol suitable for division of tasks between iterations. Persons skilled in the art, upon reviewing the entirety of this disclosure, will be aware of various ways in which steps, sequences of steps, processing tasks, and/or data may be subdivided, shared, or otherwise dealt with using iteration, recursion, and/or parallel processing.

In some embodiments, and still referring to FIG. 2, an amount of data to be transmitted over a network, for instance and without limitation in bitstream form, may be encoded using a combination of lossless and lossy coding; this may be implemented, without limitation, in a manner suitable for combined lossless and lossy VVC coding, for instance and without limitation as described below.

In an embodiment, and still referring to FIG. 2, when a VCM encoder 200 determines features to be extracted from a source video 204, the encoder may divide the source video 204 into sub-pictures, including without limitation one or more sub-pictures that contain identified features. VCM encoder 200 may inform video encoder 212, which may include without limitation a VVC encoder, about a location of sub-pictures. Video encoder 212 may then then implement lossy coding technique such as without limitation simplified Shape-Adaptive DCT (SA-DCT) algorithm to code some identified sub-pictures. A “sub-picture,” as described herein, may include any portion of a frame and/or combination of such portions; portions may include blocks, coding units, coding tree units, any combination of rectangular forms into slices and/or tiles, and/or any shape having a polygonal and/or curved perimeter.

Further referring to FIG. 2, in an exemplary embodiment, given a rectangular array of pixels, a SA-DCT process may include shifting Nj pixels of each particular column j to an uppermost position and grouping them to column vectors xj. Column vectors xj may subsequently be transformed in a vertical direction by using a one-dimensional standard DCT, which may result in corresponding vectors with vertical transform coefficients per column. Subsequently, an equivalent procedure may be repeated in a horizontal direction—in other words those Mi elements of the column vectors aj which belong to the same row i may be shifted to a leftmost position and grouped to row vectors bi, which again may be transformed with a one-dimensional standard DCT, but now in a horizontal direction, yielding row vectors ci with the entire SA-DCT coefficients. One-dimensional standard DCT operations may be performed according to the following equation:

cᵢ=S_{M}_{_{i·DCT}}_{M}_{ᵢ}·bᵢ⇐aⱼ=S_{N}_{_{j·DCT}}_{N}_{ⱼ}·xⱼ
where DCT_{L} and S_{L} represent, respectively, an L×L matrix and a shape-adaptive prefactor for L Mᵢ or Nⱼ. Inverse SA-DCT operations, usually performed after quantization, may be performed according to this equation:

$${b}_{i}^{*} = \frac{2}{{M}_{i} \cdot {S}_{{M}_{i}}} \cdot {DCT}_{{M}_{i}}^{T} \cdot {c}_{i}^{*} ⇒ {x}_{i}^{*} = \frac{2}{{N}_{j} \cdot {S}_{j}} \cdot {DCT}_{{N}_{j}}^{T} \cdot {a}_{j}^{*}$$

where starred values denote that quantization has occurred. The transform matrix DCT_{L} for a given transform L may be given according to the following equation for row and column indices p and k, where 0≤p,k≤L−1:

$${DCT}_{L} ( p , k ) = {c}_{0} \cdot cos ( p ( k + \frac{1}{2} ) \frac{π}{L} )$$

where c₀=\sqrt{½} if p=0 and 1 elsewhere. In an embodiment, an SA-DCT approach may provide a reasonable tradeoff among implementation complexity, coding efficiency and full backward compatibility to existing DCT techniques. A SA-DCT may represent a low-complexity solution having transform efficiency close to more complex DCT solutions. Alternatively or additionally, any other DCT-based or other lossy encoding protocol that may occur to a person skilled in the art upon reviewing this disclosure may be employed, including without limitation other inter coding, intra coding, and/or DCT-based approaches.

With continued reference to FIG. 2, in some embodiments, VCM decoder and/or video decoder 232 may encode other sub-pictures and/or one or more video frames to be displayed in video form using a lossless encoding protocol. Alternatively or additionally, feature encoder 220 may encode sub-pictures containing features using a lossless encoding protocol, wherein a frame is encoded and decoded with no or negligible loss of information. A lossless encoding protocol may include, without limitation, as a non-limiting example, encoder and/or decoder may accomplish lossless coding is to bypass a transform coding stage and encode residual directly. This approach, which may be referred to in this disclosure as “transform skip residual coding,” may be accomplished by skipping transformation of a residual, as described in further detail below, from spatial into frequency domain by applying a transform from the family of discrete cosine transforms (DCTs), as performed for instance in some forms of block-based hybrid video coding. Lossless encoding and decoding may be performed according to one or more alternative processes and/or protocols, including without limitation processes and/or protocols as proposed at Core Experiment CE3-1 of WET-Q00069 pertaining to regular and TS residual coding (RRC, TSRC) for lossless coding, and modifications to RRC and TSRC for lossless and lossy operation modes, Core Experiment CE3-2 of WET-Q0080, pertaining to enabling block differential pulse-code modulation (BDPCM) and high-level techniques for lossless coding, and the combination of BDPCM with different RRC/TSRC techniques, or the like.

With further reference to FIG. 2, an encoder as described in this disclosure may be configured to encode one or more fields using TS residual coding, where one or more fields may include without limitation any picture, sub-picture, coding unit, coding tree unit, tree unit, block, slice, tile, and/or any combination thereof. A decoder as described in this disclosure may be configured to decode one or more fields according to and/or using TS residual coding. In transform skip mode, residuals of a field may be coded in units of non-overlapped subblocks, or other subdivisions, of a given size, such as without limitation a size of four pixels by four pixels. A quantization index of each scan position in a field to be transformed may be coded, instead of coding a last significant scan position; a final subblock and/or subdivision position may be inferred based on levels of previous subdivisions. TS residual coding may perform diagonal scan in a forward manner rather than a reverse manner. Forward scanning order may be applied to scan subblocks within a transform block as well as positions within a subblock and/or subdivision; in an embodiment, there may be no signaling of a final (x, y) position. As a non-limiting example, a coded_sub_block_flag may be coded for every subblock except for a final subblock when all previous flags are equal to 0. Significance flag context modelling may use a reduced template. A context model of a significance flag may depend on top and left neighboring values; context model of abs_level_gt1 flag may also depend on left and top significance coefficient flag values.

As a non-limiting example, during a first scan pass in a TS residual coding process, a significance flag, a sign flag, absolute level greater than 1 flag, and parity may be coded. For a given scan position, if significance coefficient is equal to 1, then a coefficient sign flag may be coded, followed by a flag that specifies whether the absolute level is greater than 1. If an abs_level_gtX_flag is equal to 1, then the par level flag may be additionally coded to specify a parity of an absolute level. During a second or subsequent scan pass, for each scan position whose absolute level is greater than 1, up to four abs_level_gtx_flag[i] for i=1 . . . 4 may be coded to indicate if an absolute level at a given position is greater than 3, 5, 7, or 9, respectively. During a third or final “remainder” scan pass, remainder, which may be stored as absolute level abs remainder may be coded in a bypass mode. Remainder of absolute levels may be binarized using a fixed rice parameter value of 1.

Bins in a first scan pass and second or “greater-than-x” scan pass may be context coded until a maximum number of context coded bins in a field, such as without limitation a TU, have been exhausted. a maximum number of context coded bins in a residual block may be limited, in a non-limiting example, to 1.75*block_width*block_height, or equivalently, 1.75 context coded bins per sample position on average. Bins in a last scan pass such as a remainder scan pass as described above, may be bypass coded. A variable, such as without limitation RemCcbs, may be first set to a maximum number of context-coded bins for a block or other field and may be decreased by one each time a context-coded bin is coded. In a non-limiting example, while RemCcbs is larger than or equal to four, syntax elements in a first coding pass, which may include sig_coeff_flag, coeff_sign_flag, abs_level_gt1 flag and par level flag, may be coded using context-coded bins. In some embodiments, if RemCcbs becomes smaller than 4 while coding a first pass, a remaining coefficients that have yet to be coded in the first pass may be coded in the remainder scan pass and/or third pass.

After completion of first pass coding, if RemCcbs is larger than or equal to four, syntax elements in second coding pass, which may include abs_level_gt3 flag, abs_level_gt5 flag, abs_level_gt7 flag, and abs_level_gt9 flag, may be coded using context coded bins. If the RemCcbs becomes smaller than 4 while coding a second pass, remaining coefficients that have yet to be coded in the second pass may be coded in a remainder and/or third scan pass. In some embodiments, a block coded using TS residual coding may not be coded using BDPCM coding. For a block not coded in the BDPCM mode, a level mapping mechanism may be applied to transform skip residual coding until a maximum number of context coded bins has been reached. Level mapping may use top and left neighboring coefficient levels to predict a current coefficient level in order to reduce signaling cost. For a given residual position, absCoeff may be denoted as an absolute coefficient level before mapping and absCoeffMod may be denoted as a coefficient level after mapping. As a non-limiting example, where X0 denotes an absolute coefficient level of a left neighboring position and X1 denotes an absolute coefficient level of an above neighboring position, a level mapping may be performed as follows:

pred=max(X₀,X₁);if(absCoeff==pred)absCoeffMod=1;else absCoeffMod=(absCoeffMod<pred)?absCoeff+1:absCoeff

absCoeffMod value may then be coded as described above. After all context coded bins have been exhausted, level mapping may be disabled for all remaining scan positions in a current block and/or field and/or subdivision. Three scan passes as described above may be performed for each subblock and/or other subdivision if a coded subblock flag is equal to 1, which may indicate that there is at least one non-zero quantized residual in the subblock.

In some embodiments, when transform skip mode is used for a large block, the entire block may be used without zeroing out any values. In addition, transform shift may be removed in transform skip mode. Statistical characteristics of a signal in TS residual coding may be different from those of transform coefficients. Residual coding for transform skip mode may specify a maximum luma and/or chroma block size; as a non-limiting example, settings may permit transform skip mode to be used for luma blocks of size up to MaxTsSize by MaxTsSize, where a value of MaxTsSize may be signaled in a PPS and may have a global maximum possible value such as without limitation 32. When a CU is coded in transform skip mode, its prediction residual may be quantized and coded using a transform skip residual coding process.

With continued reference to FIG. 2, an encoder as described in this disclosure may be configured to encode one or more fields using BDPCM, where one or more fields may include without limitation any picture, sub-picture, coding unit, coding tree unit, tree unit, block, slice, tile, and/or any combination thereof. A decoder as described in this disclosure may be configured to decode one or more fields according to and/or using BDPCM. BDPCM may keep full reconstruction at a pixel level. As a non-limiting example, a prediction process of each pixel with BDPCM may include four main steps, which may predict each pixel using its in-block references, then reconstruct it to be used as in-block reference for subsequent pixels in the rest of the block: (1) in-block pixel prediction, (2) residual calculation, (3) residual quantization, and (4) pixel reconstruction.

Still referring to FIG. 2, in-block pixel prediction may use a plurality of reference pixels to predict each pixel; as a non-limiting example, plurality of reference pixels may include a pixel α at left of the pixel p to be predicted, a pixel β above p, and a pixel γ above and to the left of p. A prediction of p may be formulated, without limitation, as follows:

$$p \{ \begin{matrix}min ( α , β ) , if γ \leq \text{.5} max ( α , β ) \\ max ( α , β ) , if γ \geq min ( α , β ) \\ α + β - γ , Otherwise\end{matrix}$$

Still referring to FIG. 2, once a prediction value has been calculated, its residual may be calculated. Since a residual at this stage may be lossless and inaccessible at a decoder side, it may be denoted as \tilde{r} and calculated as a subtraction of an original pixel value o from prediction p:

\tilde{r}=o−p

Further referring to FIG. 2, pixel-level independence may be achieved by skipping a residual transformation and integrating a spatial domain quantization. This may be performed by a linear quantizer Q to calculate a quantized residual value r as follows:

rQ(\tilde{r})

To accommodate a correct rate-distortion ratio, imposed by a Quantizer Parameter (QP), BDPCM may adopt a spatial domain normalization used in a transfer-skip mode method, for instance and without limitation as described above. Quantized residual value r may be transmitted by an encoder.

Still referring to FIG. 2, another state of BDPCM may include pixel reconstruction using p and r from previous steps, which may be performed, for instance and without limitation at or by a decoder, as follows:

c=p+r
Once reconstructed, current pixel may be used as an in-block reference for other pixels within the same block.

A prediction scheme in an BDPCM algorithm may be used where there is a relatively large residual, when an original pixel value is far from its prediction. In screen content, this may occur where in-block references belong to a background layer, while a current pixel belongs to a foreground layer, or vice versa. In this situation, which may be referred to as a “layer transition” situation, available information in references may not be adequate for an accurate prediction. At a sequence level, a BDPCM enable flag may be signaled in an SPS; this flag may, without limitation, be signaled only if a transform skip mode, for instance and without limitation as described above, is enabled in the SPS. When BDPCM is enabled, a flag may be transmitted at a CU level if a CU size is smaller than or equal to MaxTsSize by MaxTsSize in terms of luma samples and if the CU is intra coded, where MaxTsSize is a maximum block size for which a transform skip mode is allowed. This flag may indicate whether regular intra coding or BDPCM is used. If BDPCM is used, a BDPCM prediction direction flag may be transmitted to indicate whether a prediction is horizontal or vertical. Then, a block may be predicted using regular horizontal or vertical intra prediction process with unfiltered reference samples.

Further referring to FIG. 2, at a decoding site feature decoder 236 may assist a video decoder 232, such as without limitation a VVC decoder, to decode sub-pictures for human vision; decoded features, which may be decoded according to lossless protocol in an embodiment, may be provided to video decoder 232 for assembly of entire video. In an embodiment, approaches disclosed herein may significantly reduce an amount of data to be transmitted and still maintain high quality of the decoded video.

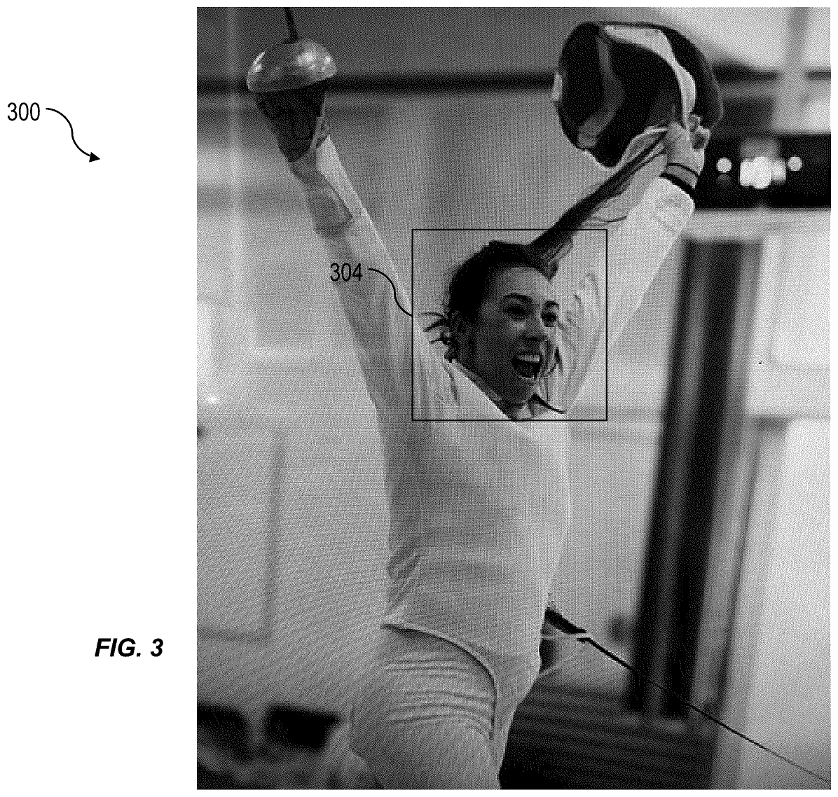

Referring now to FIG. 3, a non-limiting example of an approach disclosed herein is presented. A VCM encoder 200 may perform face recognition in a video sequence. At an encoder side a sub-picture 304 consisting of a person whose face is recognized may be identified. A face may be recognized using, without limitation, user input, an image classifier such as without limitation a neural net classifier, which may include without limitation a deep neural net classifier, a convolutional neural net classifier, a recurrent neural net classifier, or the like, a naïve Bayes classifier, a K-nearest neighbors classifier, and/or a classifier based on particle swarm optimization, ant colony optimization, and/or genetic algorithm classifier. Video with recognized face may be encoded, for instance and without limitation using any combination of lossless and lossy encoding; as a non-limiting example, areas such as sub-pictures, having high detail, high importance, or the like may be encoded with lossless coding while other areas may be encoded with lossy coding.

High-importance areas may include without limitation faces as identified by facial recognition or the like. Alternatively or additionally, identification of first region may be performed by receiving semantic information regarding one or more blocks and/or portions of frame and using semantic information to identify blocks and/or portions of frame for inclusion in first region. Semantic information may include, without limitation data characterizing a facial detection. Facial detection and/or other semantic information may be performed by an automated facial recognition process and/or program, and/or may be performed by receiving identification of facial data, semantic information, or the like from a user. Alternatively or additionally, semantic importance may be computed using significance scores.

Further referring to FIG. 3, encoder may identify first region by determining an average measure of information of a plurality of blocks and identifying the first region using the average measure of information. Identification may include, for instance, comparison of average measure of information to a threshold. Average measure of information may be determined by calculating a sum of a plurality of information measures of the plurality of blocks, which may be multiplied by a significance coefficient. Significance coefficient may be determined based on a characteristic of the first area. Significance coefficient may alternatively be received from a user. Measure of information may include, for example, a level of detail of an area of current frame. For example, a smooth area or a highly textured area may contain differing amounts of information.

Still referring to FIG. 3, an average measure of information may be determined, as a non-limiting example, according to a sum of information measures for individual blocks within an area, which may be weighted and/or multiplied by a significance coefficient, for instance a shown in the following sum:

A_{N}=S_{N}*Σₖ₌₁ⁿBₖ.

where N is a sequential number of the first area, S_{N} is a significance coefficient, k is an index corresponding to a block of a plurality of blocks making up first area, n is a number of blocks making up the area, Bₖ is a measure of information of a block of the blocks, and A_{N} is the first average measure of information. Bₖ may include, for example, a measure of spatial activity computed using a discrete cosine transform of a block. For example, where blocks as described above are 4×4 blocks of pixels, a generalized discrete cosine transform matrix may include a generalized discrete cosine transform II matrix taking the form of:

$$T = ( \begin{matrix}a & a & a & a \\ b & c & - c & - b \\ a & - a & - a & a \\ c & - b & b & - c\end{matrix} )$$

where a is ½, b is

$$\sqrt{\frac{1}{2}} cos \frac{π}{8} ,$$

and c is

$$\sqrt{\frac{1}{2}} cos \frac{3 π}{8} .$$

In some implementations, and still referring to FIG. 3, an integer approximation of a transform matrix may be utilized, which may be used for efficient hardware and software implementations. For example, where blocks as described above are 4×4 blocks of pixels, a generalized discrete cosine transform matrix may include a generalized discrete cosine transform II matrix taking the form of:

$${T}_{INT} = ( \begin{matrix}1 & 1 & 1 & 1 \\ 2 & 1 & - 1 & - 2 \\ 1 & - 1 & - 1 & 1 \\ 1 & - 2 & 2 & - 1\end{matrix} ) .$$

For a block Bᵢ, a frequency content of the block may be calculated using:

F_{Bi}=T×Bᵢ×T′.
where T′ is a transverse of a cosine transfer matrix T, Bᵢ is a block represented as a matrix of numerical values corresponding to pixels in the block, such as a 4×4 matrix representing a 4×4 block as described above, and the operation x denotes matrix multiplication. Measure of spatial activity may alternatively or additionally be performed using edge and/or corner detection, convolution with kernels for pattern detection, and/or frequency analysis such as without limitation FFT processes as described in further detail below.

Continuing to refer to FIG. 3, where encoder is further configured to determine a second area within the video frame as described in further detail below, encoder may be configured to determine a second average measure of information of the second area; determining the second average measure of information may be accomplished as described above for determining a first average measure of information.

Still referring to FIG. 3, significance coefficient SN may be supplied by an outside expert and/or calculated based on the characteristics of an area. A “characteristic” of an area, as used herein, is a measurable attribute of the area that is determined based upon its contents; a characteristic may be represented numerically using an output of one or more computations performed on first area. One or more computations may include any analysis of any signal represented by first area. One non-limiting example may include assigning higher S_{N} for an area with a smooth background and a lower S_{N} for an area with a less smooth background in quality modeling applications; as a non-limiting example, smoothness may be determined using Canny edge detection to determine a number of edges, where a lower number indicates a greater degree of smoothness. A further example of automatic smoothness detection may include use of fast Fourier transforms (FFT) over a signal in spatial variables over an area, where signal may be analyzed over any two-dimensional coordinate system, and over channels representing red-green-blue color values or the like; greater relative predominance in a frequency domain, as computed using an FFT, of lower frequency components may indicate a greater degree of smoothness, whereas greater relative predominance of higher frequencies may indicate more frequent and rapid transitions in color and/or shade values over background area, which may result in a lower smoothness score; semantically important objects may be identified by user input. Semantic importance may alternatively or additionally be detected according to edge configuration, and/or texture pattern. A background may be identified, without limitation, by receiving and/or detecting a portion of an area that represents significant or “foreground” object such as a face or other item, including without limitation a semantically important object. Another example can include assigning higher S_{N} for the areas containing semantically important objects, such as human face.

Further referring to FIG. 3, identifying first region may include determining a measure of spatial activity of each block of a plurality of blocks and identifying the first region using the measure of spatial activity. As used in this disclosure, a “spatial activity measure” is a quantity indicating how frequently and with what amplitude texture changes within a block, set of blocks, and/or area of a frame. In other words, flat areas, such as sky, may have a low spatial activity measure, while complex areas such as grass will receive a high spatial activity measure. Determination of a respective spatial activity measure may include determination using a transform matrix, such without limitation a discrete cosine transformation matrix. Determining respective spatial activity measure for each block may include determination using a generalized discrete cosine transformation matrix, which may include without limitation any discrete cosine transformation matrix as described above. For instance, determining the respective spatial activity measure for each block may include using a generalized discrete cosine transformation matrix, a generalized discrete cosine transform II matrix, and/or an integer approximation of a discrete cosine transform matrix.

In an embodiment, and still referring to FIG. 3, video encoder 212 may be informed about the sub-picture containing an identified face and/or person including the video clip size, for examples from frame 700 to frame 756. Video encoder 212 may then apply lossy encoder on this sub-picture and/or clip using a simplified SA-DCT. A feature encoder 220 may encode features and/or sub-pictures containing features using lossless encoding, which may be decoded by a feature decoder 236 using lossless decoding corresponding to lossless encoding protocol, and may be combined with decoded video at video decoder 232.

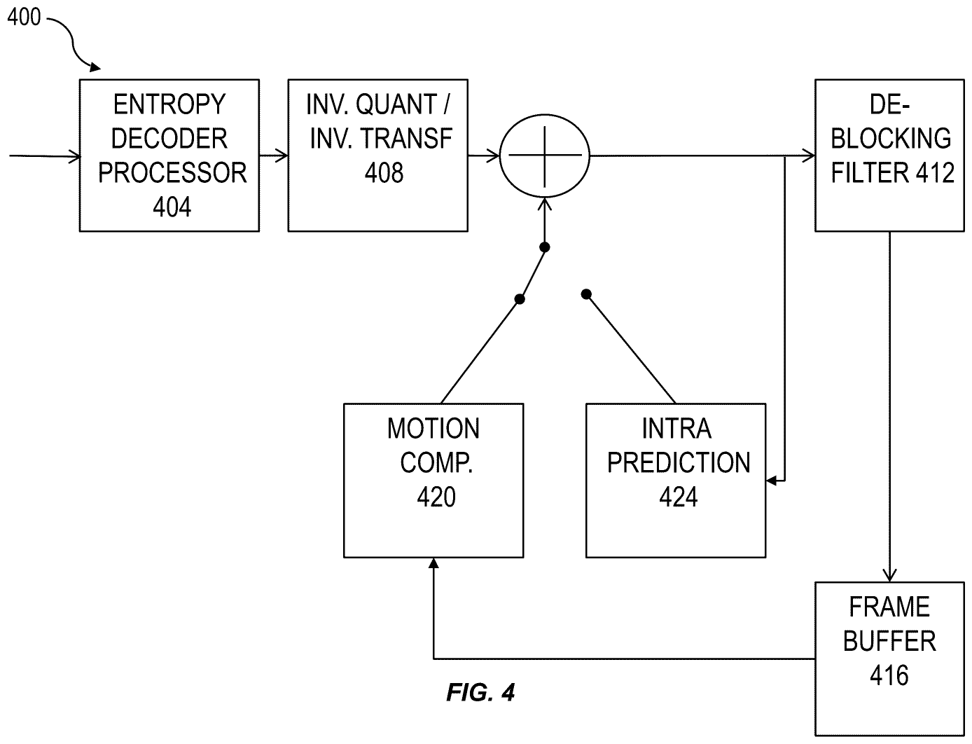

FIG. 4 is a system block diagram illustrating an example decoder 400 capable of adaptive cropping. Decoder 400 may include an entropy decoder processor 404, an inverse quantization and inverse transformation processor 408, a deblocking filter 412, a frame buffer 416, a motion compensation processor 420 and/or an intra prediction processor 424. In operation, and still referring to FIG. 4, bit stream 428 may be received by decoder 400 and input to entropy decoder processor 404, which may entropy decode portions of bit stream into quantized coefficients. Quantized coefficients may be provided to inverse quantization and inverse transformation processor 408, which may perform inverse quantization and inverse transformation to create a residual signal, which may be added to an output of motion compensation processor 420 or intra prediction processor 424 according to a processing mode. An output of the motion compensation processor 420 and intra prediction processor 424 may include a block prediction based on a previously decoded block. A sum of prediction and residual may be processed by deblocking filter 412 and stored in a frame buffer 416.

In an embodiment, and still referring to FIG. 4 decoder 400 may include circuitry configured to implement any operations as described above in any embodiment as described above, in any order and with any degree of repetition. For instance, decoder 400 may be configured to perform a single step or sequence repeatedly until a desired or commanded outcome is achieved; repetition of a step or a sequence of steps may be performed iteratively and/or recursively using outputs of previous repetitions as inputs to subsequent repetitions, aggregating inputs and/or outputs of repetitions to produce an aggregate result, reduction or decrement of one or more variables such as global variables, and/or division of a larger processing task into a set of iteratively addressed smaller processing tasks. Decoder may perform any step or sequence of steps as described in this disclosure in parallel, such as simultaneously and/or substantially simultaneously performing a step two or more times using two or more parallel threads, processor cores, or the like; division of tasks between parallel threads and/or processes may be performed according to any protocol suitable for division of tasks between iterations. Persons skilled in the art, upon reviewing the entirety of this disclosure, will be aware of various ways in which steps, sequences of steps, processing tasks, and/or data may be subdivided, shared, or otherwise dealt with using iteration, recursion, and/or parallel processing.

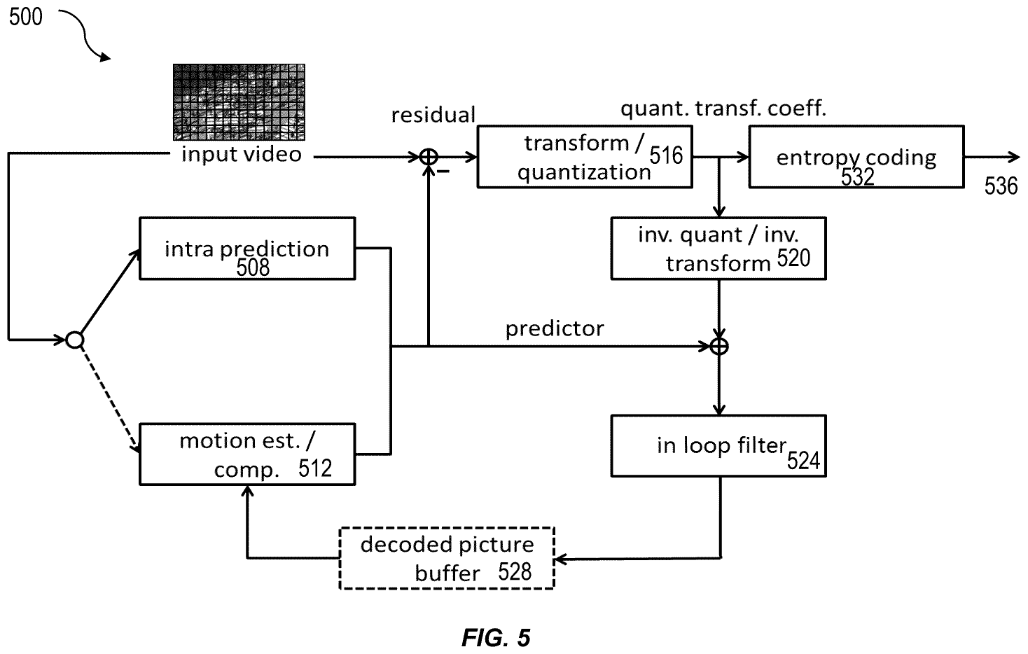

FIG. 5 is a system block diagram illustrating an example video encoder 500 capable of adaptive cropping. Example video encoder 500 may receive an input video 504, which may be initially segmented or dividing according to a processing scheme, such as a tree-structured macro block partitioning scheme (e.g., quad-tree plus binary tree). An example of a tree-structured macro block partitioning scheme may include partitioning a picture frame into large block elements called coding tree units (CTU). In some implementations, each CTU may be further partitioned one or more times into a number of sub-blocks called coding units (CU). A final result of this portioning may include a group of sub-blocks that may be called predictive units (PU). Transform units (TU) may also be utilized.

Still referring to FIG. 5, example video encoder 500 may include an intra prediction processor 508, a motion estimation/compensation processor 512, which may also be referred to as an inter prediction processor, capable of constructing a motion vector candidate list including adding a global motion vector candidate to the motion vector candidate list, a transform/quantization processor 516, an inverse quantization/inverse transform processor 520, an in-loop filter 524, a decoded picture buffer 528, and/or an entropy coding processor 532. Bit stream parameters may be input to the entropy coding processor 532 for inclusion in the output bit stream 536.

In operation, and with continued reference to FIG. 5, for each block of a frame of input video 504, whether to process block via intra picture prediction or using motion estimation/compensation may be determined. Block may be provided to intra prediction processor 508 or motion estimation/compensation processor 512. If block is to be processed via intra prediction, intra prediction processor 508 may perform processing to output a predictor. If block is to be processed via motion estimation/compensation, motion estimation/compensation processor 512 may perform processing including constructing a motion vector candidate list including adding a global motion vector candidate to the motion vector candidate list, if applicable.

Further referring to FIG. 5, a residual may be formed by subtracting a predictor from input video 54. Residual may be received by transform/quantization processor 516, which may perform transformation processing (e.g., discrete cosine transform (DCT)) to produce coefficients, which may be quantized. Quantized coefficients and any associated signaling information may be provided to entropy coding processor 532 for entropy encoding and inclusion in output bit stream 536. Entropy encoding processor 532 may support encoding of signaling information related to encoding a current block. In addition, quantized coefficients may be provided to inverse quantization/inverse transformation processor 520, which may reproduce pixels, which may be combined with a predictor and processed by in loop filter 524, an output of which may be stored in decoded picture buffer 528 for use by motion estimation/compensation processor 512 that is capable of constructing a motion vector candidate list including adding a global motion vector candidate to the motion vector candidate list.

With continued reference to FIG. 5, although a few variations have been described in detail above, other modifications or additions are possible. For example, in some implementations, current blocks may include any symmetric blocks (8×8, 16×16, 32×32, 64×64, 128×128, and the like) as well as any asymmetric block (8×4, 16×8, and the like).

In some implementations, and still referring to FIG. 5, a quadtree plus binary decision tree (QTBT) may be implemented. In QTBT, at a Coding Tree Unit level, partition parameters of QTBT may be dynamically derived to adapt to local characteristics without transmitting any overhead. Subsequently, at a Coding Unit level, a joint-classifier decision tree structure may eliminate unnecessary iterations and control the risk of false prediction. In some implementations, LTR frame block update mode may be available as an additional option available at every leaf node of QTBT.

In some implementations, and still referring to FIG. 5, additional syntax elements may be signaled at different hierarchy levels of bitstream. For example, a flag may be enabled for an entire sequence by including an enable flag coded in a Sequence Parameter Set (SPS). Further, a CTU flag may be coded at a coding tree unit (CTU) level.

Some embodiments may include non-transitory computer program products (i.e., physically embodied computer program products) that store instructions, which when executed by one or more data processors of one or more computing systems, cause at least one data processor to perform operations herein. Still referring to FIG. 5, encoder 500 may include circuitry configured to implement any operations as described above in any embodiment, in any order and with any degree of repetition. For instance, encoder 500 may be configured to perform a single step or sequence repeatedly until a desired or commanded outcome is achieved; repetition of a step or a sequence of steps may be performed iteratively and/or recursively using outputs of previous repetitions as inputs to subsequent repetitions, aggregating inputs and/or outputs of repetitions to produce an aggregate result, reduction or decrement of one or more variables such as global variables, and/or division of a larger processing task into a set of iteratively addressed smaller processing tasks. Encoder 500 may perform any step or sequence of steps as described in this disclosure in parallel, such as simultaneously and/or substantially simultaneously performing a step two or more times using two or more parallel threads, processor cores, or the like; division of tasks between parallel threads and/or processes may be performed according to any protocol suitable for division of tasks between iterations. Persons skilled in the art, upon reviewing the entirety of this disclosure, will be aware of various ways in which steps, sequences of steps, processing tasks, and/or data may be subdivided, shared, or otherwise dealt with using iteration, recursion, and/or parallel processing.

With continued reference to FIG. 5, non-transitory computer program products (i.e., physically embodied computer program products) may store instructions, which when executed by one or more data processors of one or more computing systems, causes at least one data processor to perform operations, and/or steps thereof described in this disclosure, including without limitation any operations described above and/or any operations decoder 900 and/or encoder 500 may be configured to perform. Similarly, computer systems are also described that may include one or more data processors and memory coupled to the one or more data processors. The memory may temporarily or permanently store instructions that cause at least one processor to perform one or more of the operations described herein. In addition, methods can be implemented by one or more data processors either within a single computing system or distributed among two or more computing systems. Such computing systems can be connected and can exchange data and/or commands or other instructions or the like via one or more connections, including a connection over a network (e.g. the Internet, a wireless wide area network, a local area network, a wide area network, a wired network, or the like), via a direct connection between one or more of the multiple computing systems, or the like.

It is to be noted that any one or more of the aspects and embodiments described herein may be conveniently implemented using one or more machines (e.g., one or more computing devices that are utilized as a user computing device for an electronic document, one or more server devices, such as a document server, etc.) programmed according to the teachings of the present specification, as will be apparent to those of ordinary skill in the computer art. Appropriate software coding can readily be prepared by skilled programmers based on the teachings of the present disclosure, as will be apparent to those of ordinary skill in the software art. Aspects and implementations discussed above employing software and/or software modules may also include appropriate hardware for assisting in the implementation of the machine executable instructions of the software and/or software module.

Such software may be a computer program product that employs a machine-readable storage medium. A machine-readable storage medium may be any medium that is capable of storing and/or encoding a sequence of instructions for execution by a machine (e.g., a computing device) and that causes the machine to perform any one of the methodologies and/or embodiments described herein. Examples of a machine-readable storage medium include, but are not limited to, a magnetic disk, an optical disc (e.g., CD, CD-R, DVD, DVD-R, etc.), a magneto-optical disk, a read-only memory “ROM” device, a random-access memory “RAM” device, a magnetic card, an optical card, a solid-state memory device, an EPROM, an EEPROM, and any combinations thereof. A machine-readable medium, as used herein, is intended to include a single medium as well as a collection of physically separate media, such as, for example, a collection of compact discs or one or more hard disk drives in combination with a computer memory. As used herein, a machine-readable storage medium does not include transitory forms of signal transmission.

Such software may also include information (e.g., data) carried as a data signal on a data carrier, such as a carrier wave. For example, machine-executable information may be included as a data-carrying signal embodied in a data carrier in which the signal encodes a sequence of instruction, or portion thereof, for execution by a machine (e.g., a computing device) and any related information (e.g., data structures and data) that causes the machine to perform any one of the methodologies and/or embodiments described herein.

Examples of a computing device include, but are not limited to, an electronic book reading device, a computer workstation, a terminal computer, a server computer, a handheld device (e.g., a tablet computer, a smartphone, etc.), a web appliance, a network router, a network switch, a network bridge, any machine capable of executing a sequence of instructions that specify an action to be taken by that machine, and any combinations thereof. In one example, a computing device may include and/or be included in a kiosk.

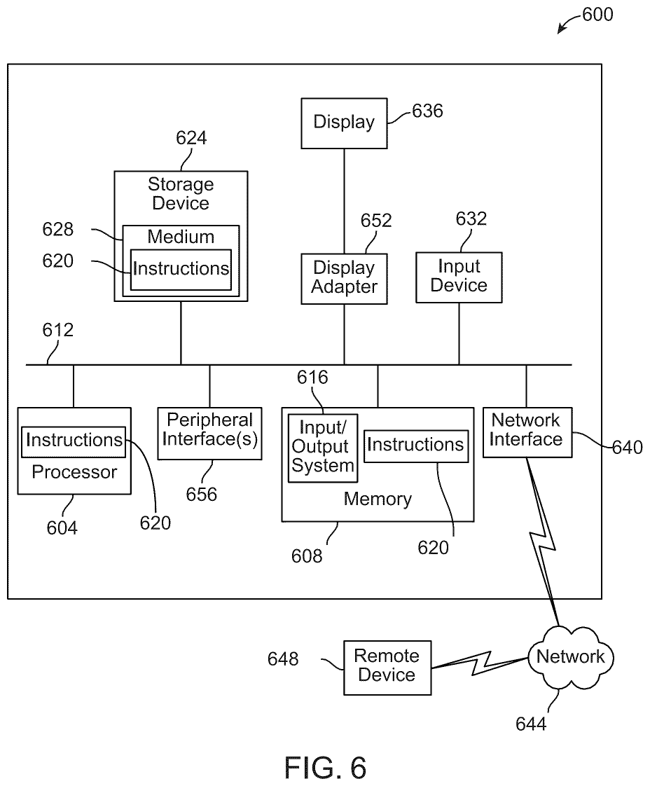

FIG. 6 shows a diagrammatic representation of one embodiment of a computing device in the exemplary form of a computer system 600 within which a set of instructions for causing a control system to perform any one or more of the aspects and/or methodologies of the present disclosure may be executed. It is also contemplated that multiple computing devices may be utilized to implement a specially configured set of instructions for causing one or more of the devices to perform any one or more of the aspects and/or methodologies of the present disclosure. Computer system 600 includes a processor 604 and a memory 608 that communicate with each other, and with other components, via a bus 612. Bus 612 may include any of several types of bus structures including, but not limited to, a memory bus, a memory controller, a peripheral bus, a local bus, and any combinations thereof, using any of a variety of bus architectures.

Processor 604 may include any suitable processor, such as without limitation a processor incorporating logical circuitry for performing arithmetic and logical operations, such as an arithmetic and logic unit (ALU), which may be regulated with a state machine and directed by operational inputs from memory and/or sensors; processor 604 may be organized according to Von Neumann and/or Harvard architecture as a non-limiting example. Processor 604 may include, incorporate, and/or be incorporated in, without limitation, a microcontroller, microprocessor, digital signal processor (DSP), Field Programmable Gate Array (FPGA), Complex Programmable Logic Device (CPLD), Graphical Processing Unit (GPU), general purpose GPU, Tensor Processing Unit (TPU), analog or mixed signal processor, Trusted Platform Module (TPM), a floating-point unit (FPU), and/or system on a chip (SoC).

Memory 608 may include various components (e.g., machine-readable media) including, but not limited to, a random-access memory component, a read only component, and any combinations thereof. In one example, a basic input/output system 616 (BIOS), including basic routines that help to transfer information between elements within computer system 600, such as during start-up, may be stored in memory 608. Memory 608 may also include (e.g., stored on one or more machine-readable media) instructions (e.g., software) 620 embodying any one or more of the aspects and/or methodologies of the present disclosure. In another example, memory 608 may further include any number of program modules including, but not limited to, an operating system, one or more application programs, other program modules, program data, and any combinations thereof.

Computer system 600 may also include a storage device 624. Examples of a storage device (e.g., storage device 624) include, but are not limited to, a hard disk drive, a magnetic disk drive, an optical disc drive in combination with an optical medium, a solid-state memory device, and any combinations thereof. Storage device 624 may be connected to bus 612 by an appropriate interface (not shown). Example interfaces include, but are not limited to, SCSI, advanced technology attachment (ATA), serial ATA, universal serial bus (USB), IEEE 1394 (FIREWIRE), and any combinations thereof. In one example, storage device 624 (or one or more components thereof) may be removably interfaced with computer system 600 (e.g., via an external port connector (not shown)). Particularly, storage device 624 and an associated machine-readable medium 628 may provide nonvolatile and/or volatile storage of machine-readable instructions, data structures, program modules, and/or other data for computer system 600. In one example, software 620 may reside, completely or partially, within machine-readable medium 628. In another example, software 620 may reside, completely or partially, within processor 604.

Computer system 600 may also include an input device 632. In one example, a user of computer system 600 may enter commands and/or other information into computer system 600 via input device 632. Examples of an input device 632 include, but are not limited to, an alpha-numeric input device (e.g., a keyboard), a pointing device, a joystick, a gamepad, an audio input device (e.g., a microphone, a voice response system, etc.), a cursor control device (e.g., a mouse), a touchpad, an optical scanner, a video capture device (e.g., a still camera, a video camera), a touchscreen, and any combinations thereof. Input device 632 may be interfaced to bus 612 via any of a variety of interfaces (not shown) including, but not limited to, a serial interface, a parallel interface, a game port, a USB interface, a FIREWIRE interface, a direct interface to bus 612, and any combinations thereof. Input device 632 may include a touch screen interface that may be a part of or separate from display 636, discussed further below. Input device 632 may be utilized as a user selection device for selecting one or more graphical representations in a graphical interface as described above.

A user may also input commands and/or other information to computer system 600 via storage device 624 (e.g., a removable disk drive, a flash drive, etc.) and/or network interface device 640. A network interface device, such as network interface device 640, may be utilized for connecting computer system 600 to one or more of a variety of networks, such as network 644, and one or more remote devices 648 connected thereto. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network, such as network 644, may employ a wired and/or a wireless mode of communication. In general, any network topology may be used. Information (e.g., data, software 620, etc.) may be communicated to and/or from computer system 600 via network interface device 640.

Computer system 600 may further include a video display adapter 652 for communicating a displayable image to a display device, such as display device 636. Examples of a display device include, but are not limited to, a liquid crystal display (LCD), a cathode ray tube (CRT), a plasma display, a light emitting diode (LED) display, and any combinations thereof.

Display adapter 652 and display device 636 may be utilized in combination with processor 604 to provide graphical representations of aspects of the present disclosure. In addition to a display device, computer system 600 may include one or more other peripheral output devices including, but not limited to, an audio speaker, a printer, and any combinations thereof. Such peripheral output devices may be connected to bus 612 via a peripheral interface 656. Examples of a peripheral interface include, but are not limited to, a serial port, a USB connection, a FIREWIRE connection, a parallel connection, and any combinations thereof.

The foregoing has been a detailed description of illustrative embodiments of the invention. Various modifications and additions can be made without departing from the spirit and scope of this invention. Features of each of the various embodiments described above may be combined with features of other described embodiments as appropriate in order to provide a multiplicity of feature combinations in associated new embodiments. Furthermore, while the foregoing describes a number of separate embodiments, what has been described herein is merely illustrative of the application of the principles of the present invention. Additionally, although particular methods herein may be illustrated and/or described as being performed in a specific order, the ordering is highly variable within ordinary skill to achieve methods, systems, and software according to the present disclosure. Accordingly, this description is meant to be taken only by way of example, and not to otherwise limit the scope of this invention.

Exemplary embodiments have been disclosed above and illustrated in the accompanying drawings. It will be understood by those skilled in the art that various changes, omissions and additions may be made to that which is specifically disclosed herein without departing from the spirit and scope of the present invention.

What is claimed is:

1. A video coding for machines (VCM) encoder comprising:
a feature encoder, the feature encoder configured to receive source video and encode a sub-picture containing a feature in an input video and provide an indication of the sub-picture; and
a video encoder, the video encoder configured to receive source video, receive an indication of the sub-picture from the feature encoder, and encode the sub-picture using a lossy encoding protocol; and
a multiplexor coupled to the feature encoder and video encoder and providing a encoded bitstream

2. The VCM encoder of claim 1 further comprising a feature extractor configured to identify the sub-picture.

3. The VCM encoder of claim 1, wherein the feature encoder is further configured to encode the sub-picture using a lossless encoding protocol.

4. The VCM encoder of claim 3, wherein the lossless encoding protocol is a transform skip residual coding protocol

5. The VDM encoder of claim 3, wherein the encoder enables block differential pulse-code modulation.

6. The VCM encoder of claim 1, wherein the feature encoder is further configured to encode the sub-picture using a lossy encoding protocol.

7. The VCM encoder of claim 1, wherein the lossy encoding protocol includes a discrete cosine transform encoding protocol.

8. The VCM encoder of claim 4, wherein the discrete cosine transform encoding protocol includes a shape-adaptive discrete cosign transform encoding protocol.

9. The VCM encoder of claim 1, further configured to signal the sub-picture to a decoder.

10. The VCM encoder of claim 8, wherein signaling the sub-picture further comprises signaling a sequence of frames including the sub-picture.

11. The VCM encoder of claim 8, wherein signaling the sub-picture further comprises signaling a type of feature included in the sub-picture.

12. A VCM decoder comprising:
a feature decoder, the feature decoder receiving an encoded bitstream having encoded feature data and video data therein, the decoder providing decoded feature data for machine consumption;
a video decoder, the video decoder receiving the encoded bitstream and feature data from the feature decoder, the video decoder providing decoded video suitable for a human viewer.

13. The VCM decoder of claim 12, wherein the video decoder is configured to decode an encoded bitstream coded with the VVC standard.

14. The VCM decoder of claim 12, wherein the video decoder is configured to decode the bitstream encoded using a transform skip residual coding protocol

15. The VCM decoder of claim 12, wherein the decoder is further configured to decode a bitstream encoded using block differential pulse-code modulation.
